(19) United States
(12) Patent Application Publication
(10) Pub. No.: US 2023/0372174 A1
(43) Pub. Date: Nov. 23, 2023

(54) IMPROVED DEVICE FOR PROVIDING A CLEAN AIR ZONE, E.G. A CONTROLLED PERSONAL BREATHING ZONE

(71) Applicant: AIRSONETT AB, Angelholm (SE)

(72) Inventor: Pål Martin SVENSSON, Angelholm (SE)

(73) Assignee: AIRSONETT AB, Angelholm (SE)

(21) Appl. No.: 18/246,987

(22) PCT Filed: Sep. 21, 2021
(86) PCT No.: PCT/EP2021/075889

§ 371 Date: Mar. 28, 2023

(30) Foreign Application Priority Data
Oct. 14, 2020 (EP) 20201791.9
Jul. 12, 2021 (EP) 21185059.9

(51) Int. Cl. A61G 10/02; F24F 5/00; F24F 8/95; F24F 8/10

(52) U.S. Cl. CPC A61G 10/02; F24F 5/0042; F24F 8/95; F24F 8/10

(57) ABSTRACT

The present invention relates to an improved device for supplying temperature controlled laminar air flow (TLA) of filtered air to generate a clean air zone, e.g. a controlled personal breathing zone, at a point of care. The specific relative placement of the air inlets and outlets of the device of the present invention enables the provision of a more stable TLA based clean air zone than the prior art devices and at the same time allows for extensive monitoring and reporting features.

### FIELD OF THE INVENTION

This invention relates to an improved air treatment device adapted for providing cleaned air to a clean air zone, e.g. to generate a controlled personal breathing zone, and to improved methods for providing cleaned air to a clean air zone, e.g. to generate a controlled personal breathing zone.

### BACKGROUND

Temperature-controlled laminar air flow (abbreviated TLA) involves providing a substantially laminar, descending downwardly directed flow of air. The descending air flow in TLA stems from the fact that the air provided is slightly (typically 0.1 to 3° C., e.g 0.3 to 1° C. or 0.5 to 0.8° C.) cooler than the ambient air. Prior art describes how air flow and temperature can during the operation of a TLA device be carefully regulated to a level, which just counters the upwardly directed flow generated by e.g. the body convection of an individual in the need of care resting in or on a resting place (e.g. bed). Because the descending laminar air flow will in such a situation only be mixed with the ambient air to a very little extent at the boundaries of the clean air zone, TLA can if carefully controlled be used to effectively generate a zone of cleaned air surrounding a point of care, e.g. generate a controlled breathing zone of a resting individual in need of care, without leaving a sense of draught.

The supply of a cleaned flow of air supplied in the form of TLA (thereby e.g. generating a personal breathing zone in accordance with the above) during e.g. periods of sleep has been found to alleviate the symptoms of atopic asthmatics (Boyle R J, Pedroletti C, Wickman M, et al. Nocturnal temperature controlled laminar airflow for treating atopic asthma: a randomised controlled trial. Thorax 2012; 67:215-221; Pedroletti C, Millinger E, Dahlén B, et al. Clinical effects of purified air administered to the breathing zone in allergic asthma: A double-blind randomized cross-over trial. Respir Med 2009; 103:1313-9; Schauer U, Bergmann K-C, Gerstlauer M, et al. Improved asthma control in individual in need of cares with severe persistent allergic asthma after 12 months of nightly temperature-controlled laminar airflow (TLA): An observational study with retrospective comparisons. Eur Clin Respir J 2015; 2:28531) as well as other allergic conditions such as atopic eczema (Brazier P et al. (2016) BMJ Open Resp Res 2016; 3:e000117; Gore C, Gore R B, Fontanella S, et al. Temperature-controlled laminar airflow (TLA) device in the treatment of children with severe atopic eczema: Open-label, proof-of-concept study. Clin Exp Allergy. 2018 May; 48(5):594-603).

Several devices that enables a reduction of more than 75%, and in some cases a reduction of up to 95%, exposure to residential airborne contaminants, such as allergens and pollutants, by providing cleaned air to a clean air zone (e.g. generating a controlled personal breathing zone of a resting individual in need of care) in the form of cleaned air supplied by TLA in accordance with the above have been described in the prior art.

WO2005/017419 (A1) discloses an air supply device for generating zones of clean air where the air supplied has a lower temperature than the ambient air, and wherein the air is supplied through an air permeable body the outer part of which has passages which are substantially rectilinear, substantially uniform in thickness and have a length which is at least four times greater than their width.

U.S. Pat. No. 7,037,188 (B2) discloses systems, including a blower unit, which produces a condi-tioned air flow and delivers it to a person's breathing zone. The systems are described as relying on the temperature difference between the air near the floor (i.e. beneath a bed) and that above a bed (cf. sections [0093], [0097] and [0098]).

U.S. Pat. No. 8,956,442 (B2) discloses methods and devices for improving microvascular function in humans and mammals by reducing the exposure to airborne fine particles using TLA air treatment systems.

WO 2011/042801 (A1) discloses methods and devices whereby a controlled personal breathing zone is maintained using TLA. The devices are described as preferably having one or more air inlets placed near the floor level of the premises in which the device is utilized (cf. p. 7 I. 17-18 and FIG. 3).

WO2011/114186 (A1) discloses methods and devices for displacing body convection by use of TLA, thereby reducing exposure to allergens and other airborne fine particles within a personal breathing zone during situations of or corresponding to sleep. The devices are described as preferably having one or more air inlets placed near the floor level of the premises in which the device is utilized (cf. p. 14 I. 28-29 and FIG. 3). WO2012/136728 (A1) discloses methods and devices for treating atopic dermatitis relying on TLA air treatment. The devices are described as preferably having one or more air inlets placed near the floor level of the premises in which the device is utilized (cf. p. 9 I. 19-20 and FIG. 3).

Although the specific devices disclosed in the above-mentioned references are highly effective, they are also relatively large, and their operation involves a relatively high energy consumption as well as a relatively high noise level.

More importantly, however, the efficient functioning of all of the specific devices disclosed in the above-mentioned references to a certain degree depend on the specific placement of the device relative to both the clean air zone generated, e.g. a controlled personal breathing zone of a resting individual in need of care, and the immediate surroundings. Thus, both growing and continued use of the specific prior art devices disclosed in the above-mentioned references and later research (see e.g. Gore et al, Effect of a novel temperature-controlled laminar airflow device on personal breathing zone aeroallergen exposure, Indoor Air 2015; 25: 36-44) has revealed that these specific devices are prone to displaying a limited efficiency in a significant number of real-life situations. In fact in order for optimal function of the prior art devices, the air supplied from the air outlets of the devices and slowly descending to the point of care as a temperature-controlled laminar air flow (TLA) needs to be able to freely move away from the point of care (e.g. the controlled personal breathing zone) in all directions, i.e. the prior art devices only function optimally when unhindered movement of air is possible in all directions away from the clean air zone generated at the point of care, i.e. in all directions covered by the 360° circumference making up the boundary of the clean TLA flow supplied to the clean air zone at the point of care.

In many real-life situations, however, air can only truly freely move away from the point of care in one or two general directions relative to (and be evacuated from) the clean air zone generated at the point of care, e.g. the resting place (e.g. bed) in or on which an individual in need of care is resting. Thus, in may real-life situations, the possible directions in which air can truly move away from the point of care will cover only a minor part of the circumference making up the clean air zone generated by the TLA flow otherwise supplied to the area of the point of care. Thus, in many scenarios true free evacuation of air at the point of care is only possible perpendicularly to one of the sides of the point of care, e.g. resting place (e.g. bed), and in most scenarios only in one direction. In case of a controlled personal breathing zone this can e.g. be in the direction of the foot end of the resting place (e.g. bed). In many cases air cannot move in the direction of the head end of the resting place (e.g. bed) and in many cases also not perpendicularly to the opposite side of the resting place (e.g. bed) since the resting place (e.g. bed) is frequently placed alongside a least one wall and in many cases is placed in a corner. This is inter alia a typical situation for e.g. children lying in their bed.

Similar situations, as regards the spatially limited evacuation of air at the point of care, are seen in case of clean air zones generated in case of workstations (e.g. comprising a working table) operating rooms, surgical theatres, instrument tables and the like.

This limitation as regards the possible free movement (evacuation) of air away from the point of care can significantly impact both the size and the cleanliness of the clean zone otherwise intended to be generated by the device at the point of care.

Finally, continued use has revealed that the design of the prior art devices may still be further optimized when it comes to optimising therapeutic compliance and facilitating the performance of standard maintenance procedures, such as e.g. filter-change, by the user, without an accompanying risk of unwanted contamination of the clean-zone through spillage of material from the used filter.

### SUMMARY OF THE INVENTION

The general object of the present invention is to provide an improved air treatment device for providing a descending temperature-controlled, clean and substantially laminar, air flow (TLA) to a point of care, which is more stable (i.e. compared to those provided by prior art devices) thereby generating a better controlled and more stable clean air zone, e.g. a personal breathing zone of a resting individual in need of care, at the point of care.

Apart from encompassing the point of care at the level of the geometrical centre point of the point of care, said TLA generated clean air zone, e.g. personal breathing zone of a resting individual in need of care, will, by way of it being provided from the air outlets of said air treatment device, also encompass a certain volume of space between the air outlets of said air treatment device and the point of care at the level of the geometrical centre point of the point of care.

Compared to the prior art devices, the devices of the present invention allow for both an improved cleanliness of the TLA generated clean air zone, e.g. personal breathing zone of a resting individual in need of care, an improved clean air distribution and an improved evacuation of air from the clean air zone at the point of care, leading to a significant improvement of the stability of the clean air zone generated at the point of care and a significant reduction in the time needed for the clean air zone generated at the point of care to recover if having been disturbed, e.g. by movements of an individual in need of care resting at the point of care. In addition the devices of the present invention are not dependent on air inlet air placed below the level of the geometrical centre point of the point of care, e.g. from floor level, and, hence, are, in contrast to the devices of the prior art, not relying on a thermal stratification at floor level for efficient functioning. Quite to the contrary the devices of the present invention rely on a supply of air, which has at least partly been evacuated from the immediate proximity of the clean air zone, e.g. personal breathing zone, generated at the point of care, either at or directly above the level of the geometrical centre point of the point of care. In preferred embodiments the supply air provided from the outlets is evacuated from the immediate proximity of the clean air zone, e.g. personal breathing zone, generated at the point of care either at or directly above the level of the geometrical centre point of the point of care.

The devices according to the present invention may be characterised inter alia by the following features:
supply air provided from the outlet(s) (10) as a TLA flow towards the point of care (2) is continuously evacuated from the immediate proximity of the clean air zone (31) generated inter alia at the point of care (2) when said device (1) is in use, by provision of one or more air inlets (4) located in the immediate proximity of said controlled clean air zone (31), either at or directly above the level (35) of the geometrical centre point (37) of the point of care (2),
they are preferably wall mounted and or fitted on a stand that can be attached to e.g. a headboard of a bed or the like,
the filter (7) is located in a filter chamber, e.g. in the form of a flat filter, and can easily be changed,
the means for providing the clean air supply includes an impeller type device, e.g. inline turbo impeller (15),
they rely on enhanced noise reduction, e.g. by the use of perforated sheet with cavities (27)
they rely on motor control, e.g. sinusodial
they rely on motor suspension, e.g silicon
they include a cooling heat sink configuration (29), e.g. cylindrical
they rely on peltier configuration (28), e.g. displaying a coefficient of performance (COP)>1
they rely on automatic start/stop, e.g. by use of an infrared camera (13) monitoring the presence or absence of an individual at the point of care.

The TLA-devices disclosed herein, thus, differ from the specific prior art devices disclosed in the above-mentioned references in that air is much more efficiently evacuated/displaced from the point of care (2) during real-life situations, and thereby the correct functioning of the TLA devices disclosed herein is less dependent on their specific placement; and in that they are designed to facilitate self-assisted operation and maintenance and are optionally equipped with sensors (13) and control units to provide for automatic operation and monitoring and reporting facilities.

### BRIEF DESCRIPTION OF THE FIGURES

A further understanding of the nature and advantages of the present invention may be realized by reference to the remaining portions of the specification and the accompanying figures. In the following, preferred embodiments of the invention are explained in more detail with reference to the figures, wherein:

FIG. 1 shows a preferred embodiment and a specific use of an air treatment device (1) according to the invention, including the TLA-based clean air zone (31) generated inter alia at a point of care (2). The device shown has been adapted to provide a substantially laminar descending purified air flow (36) downwards towards said point of care (2) having a difference in air temperature to the ambient air (34), as measured at the point of care (2) at the level (35) of the geometrical centre point (37) of the point of care (2), within a range of 0.1 to 3° C., cooler than the ambient air (34) at the level (35) of the geometrical centre point (37) of the point of care (2), said device comprising:
one or more air inlets (4),
one or more air outlets (10), the at least one of said outlets (10) is located above the level (35) of the geometrical centre point (37) of the point of care (2) and adapted to discharge said substantially laminar, downwardly directed purified air flow (36),
one or more filters (7, not shown in FIG. 1),
a fan assembly (5, not shown in FIG. 1),
an air temperature adjustment system adapted to provide either heating or cooling of said supply air stream, and
a housing (6),

said device being further characterised in that at least one of said one or more air inlets (4) is/are located in the immediate proximity of said controlled clean air zone (31) generated inter alia inter alia at the point of care (2) by the device (1) when in use, either at or directly above the level (35) of the geometrical centre point (37) of the point of care (2) and at a distance, R2, from the geometrical centre point (37) of said clean air zone (31) at the point of care (2), at the level (35) of the geometrical centre point (37) of the point of care (2), which distance, R2, is larger than, but less than two times, the distance, R1, from the same geometrical centre point (37) of said clean air zone (31) at the point of care (2) to the “outer boundary” of said clean air zone (31), at the level (35) of the geometrical centre point (37) of the point of care (2). Also, in the embodiment shown in FIG. 1 the air treatment device (1) has been adapted to generate said controlled clean air zone (31) at said point of care (2) by displacing body convection from an individual in need of care (3) at rest at said point of care (2) thereby generating said controlled clean air zone (31) in the form of a controlled personal breathing zone for said individual (3) at rest at said point of care (2), and the air inlets (4) placed in the immediate proximity of the clean air zone (31) for the evacuation of air from the clean air zone (31) are in the embodiment shown in FIG. 1 placed directly above the point of care.

FIGS. 2a and 2b show two embodiments of an air treatment device (1) according to the present invention, including the placement of the air inlets (4) relative to the typical clean air zone (31) generated inter alia by a device according to the present invention when in use. Thus, the embodiments shown in FIGS. 2a and 2b include:
one or more air inlets (4),
one or more air outlets (10) adapted to discharge a substantially laminar, downwardly directed purified air flow,
one or more filters (7),
a fan assembly (5),
an air temperature adjustment system adapted to provide either heating or cooling of said supply air stream, and
a housing (6),

FIG. 3 shows an embodiment of an air treatment device according to the present invention comprising a release mechanism which enables the change of the filter (7) when in an unlocked horizontal or nearby horizontal position in a way whereby only the clean side of the filter (8) is exposed to the surroundings.

FIG. 4a1, 4a2, 4b, 4c, and 4d shows different embodiments of air treatment devices according to the present invention (4a1, 4a2, 4c and 4d) and an air treatment device of the prior art (4b), and how these may be used to generate a controlled personal breathing zone for an individual at rest at a point of care. FIG. 4e show a close-up of the primary direction vector of the air flow (38) into an air inlet (4) of a device according to the present invention.

FIG. 5 shows the performance of a prior art device (AIR 4, i.e. a device as described in WO2012/136728) compared to the performance of a device according to the present invention (AIR 5) as regards the ability of the devices to stably maintain the controlled clean air zone (31) generated inter alia at a point of care (2) at the level (35) of the geometrical centre point (37) of the point of care (2), when the devices are in use. The data shown is a graphical representation of the particle cleanliness of the clean air zone (31) at different positions/distances (Ø/R) from the geometrical centre point (37) at the level (35) of the geometrical centre point (37) of the point of care (2), and are an average of measurements with a point of care (2), in the form of a bed, placed next to a wall and a free-standing point of care (2) in the form of a free standing bed, respectively.

### DETAILED DESCRIPTION

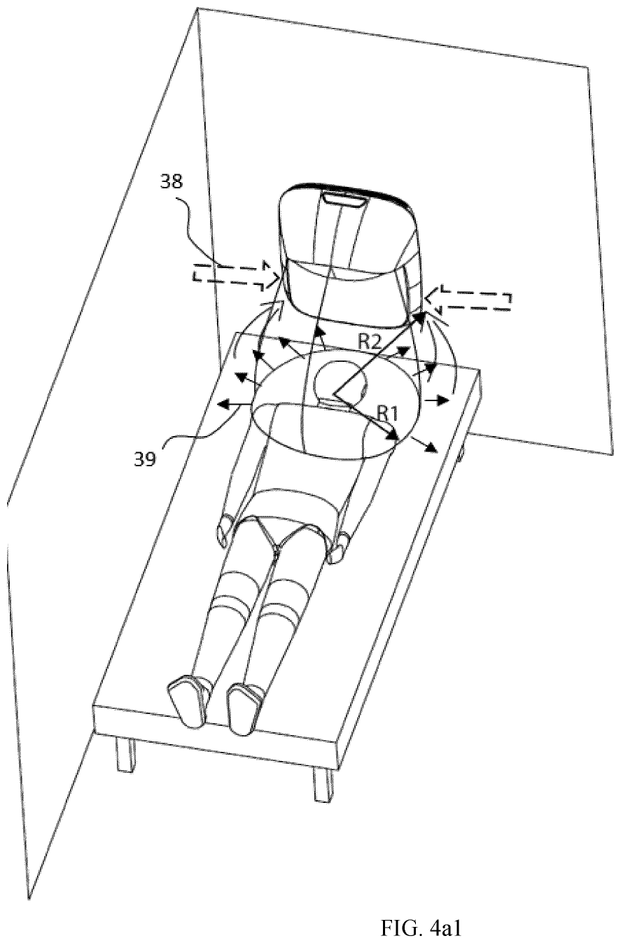

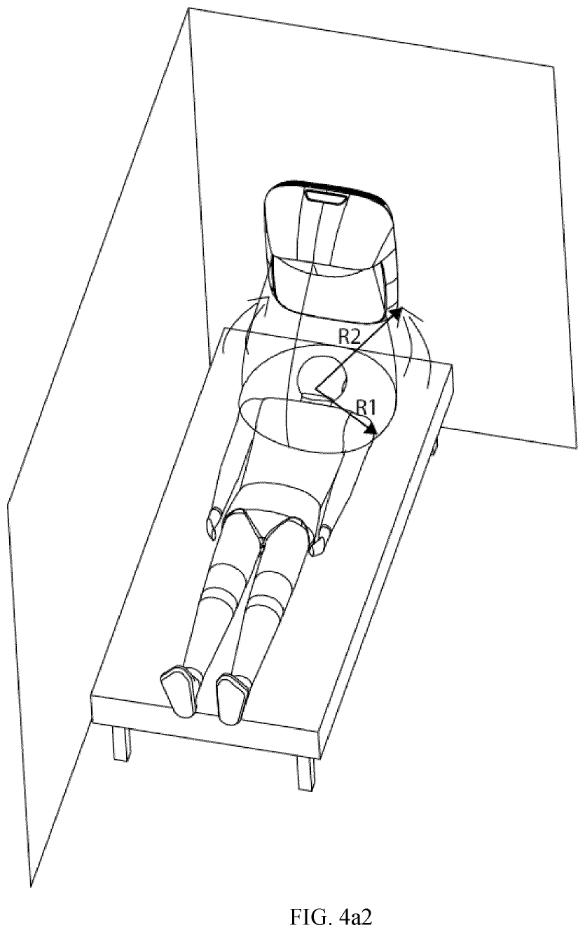

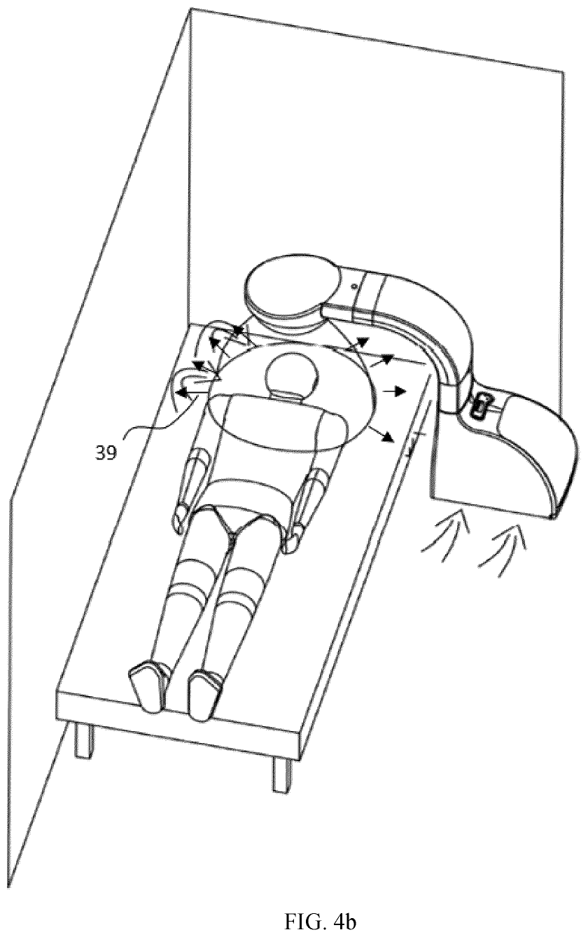

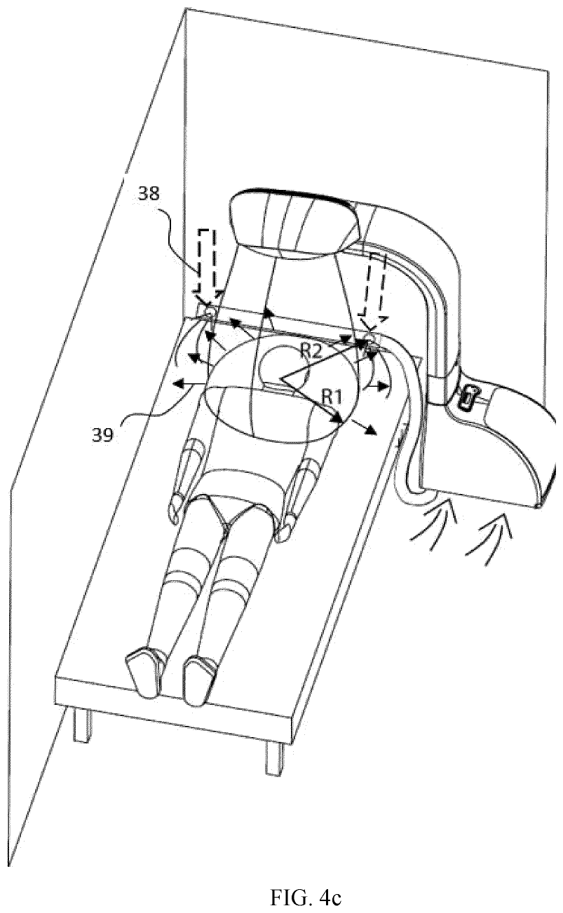

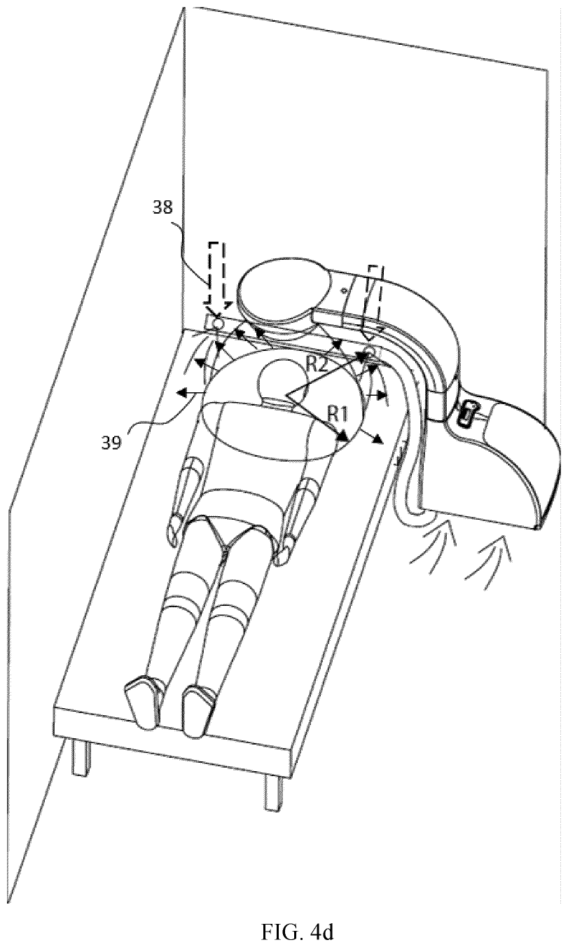

The present invention will now be described more fully hereinafter with reference to the accompanying figures, especially FIGS. 4a1 and 4a2 in which exemplary embodiments of the invention are shown. The invention may, however, be embodied in different forms, e.g. as shown in FIGS. 4c, 4d and 4e, and should not be construed as limited to the specific embodiments set forth herein. Rather, these embodiments are provided so that this disclosure will be thorough and complete, and will fully convey the scope of the invention to those skilled in the art.

The TLA devices of the present invention are characterised in that they comprise:
one or more air inlets (4) located in the immediate proximity of the clean air zone (31) generated by the device inter alia at the point of care (2) when in use, either at or directly above the level (35) of the geometrical centre point (37) of the point of care (2)
one or more air outlets (10), located above the level of the clean air zone (31) at the point of care (2), and adapted to discharge a substantially laminar, downwardly directed air flow,
   one or more filters (7)
   a fan assembly (5),
   an air temperature adjustment system adapted to provide either heating or cooling of a supply air stream, and
   a housing (6),

The clean air zone (31) generated inter alia at the point of care (2) by a device according to the present invention may be of use in multiple situations. Thus, the provision a clean air zone (31) can be pivotal in the context of e.g. workstations (e.g. work tables), fume cupboards/hoods, surgical theaters, or surgical instrument tables.

In preferred embodiments, the TLA devices of the present invention are used for displacing body convection from an individual in need of care at rest and generating a clean air zone (31), e.g. a controlled personal breathing zone, for said individual at rest at a point of care (2). In such embodiments the TLA devices of the present invention are characterised in that they comprise:
one or more air inlets (4) located in the immediate proximity of the clean air zone (31), e.g. a controlled personal breathing zone, generated by the device at the point of care (2) when in use, either at or directly above the level (35) of the geometrical centre point (37) of the point of care (2),
one or more air outlets (10), located above the level of the personal breathing zone at the point of care (2), and adapted to discharge a substantially laminar, downwardly directed purified air flow (36),
one or more filters (7)
a fan assembly (5),
an air temperature adjustment system adapted to provide either heating or cooling of a supply air stream, and
a housing (6),

In the context of the present invention an individual in the need of care is to be understood as being any kind of individual in need of care. That is to say, said individual in need of care may be a mammal, e.g. a human, or any other animal, such as a bird, a reptile, an amphibian or an invertebrate.

In the context of the present invention a clean air zone (31) generated by an air treatment device according to the present invention when in use is to be understood as being substantially free of in-mixed, contaminated ambient air at least at the point of care (2). Thus, a zone of treated air supplied from the outlets (10) of an air treatment device according to the present invention may provide more than 95% reduction in airborne fine particle counts (i.e. particulate matter particles ≤2.5 μm) at the point of care (2), e.g. as much as a 99.5% reduction, and typically provides at least more than 75% reduction in airborne fine particle counts at the point of care (2) when in use. In certain preferred embodiments more than 95% of particles ≥0.5 μm present in the ambient air are removed from the treated air supplied from the outlets (10) of an air treatment device according to the present invention when in use. In a particularly preferred embodiment an air treatment device according to the invention will in accordance with the performance reported also for prior art devices, supply air from its outlet(s) (10), which generates a clean air zone (31), e.g. personal breathing zone, wherein the cat allergen concentration is reduced by a factor of 30 and total breathing zone particulate exposure by a factor of 3000 for particles >0.5 μm and 3700 for particles >10 μm. Thus, effectively reducing aeroallergen such as pet dander (predominately <5 μm) and house dust mites (>10 μm) exposure at the point of care (2) when in use.

As noted above, said TLA generated clean air zone (31), e.g. personal breathing zone, will, by way of it being provided from the air outlets (10) of said air treatment device, apart from encompassing the point of care (2) at the level (35) of the geometrical centre point (37) of the point of care (2), also encompass a certain volume of space between the air outlet(s) (10) of said air treatment device and the point of care (2).

In the context of the present invention the “outer boundary” of said volume of space occupied by said TLA based clean air zone (31) generated by an air treatment device according to the present invention, e.g. personal breathing zone, is, thus, to be understood as being the “surface”, defined by the discrete points in the space between the air outlets (10) of said air treatment device and the point of care (2) at the level (35) of the geometrical centre point (37) of the point of care (2), at which the level of airborne fine particle counts (i.e. particulate matter particles s 2.5 μm), in the air is reduced at least 75% compared to that of the ambient air when in use. In certain preferred embodiments the “outer boundary” is to be understood as the “surface”, defined by the discrete points in the space between the air outlets (10) of said air treatment device and the point of care (2) at the level (35) of the geometrical centre point (37) of the point of care (2), at which at least 95% of particles larger than 0.5 μm, e.g. as much as a 99.5% of particles larger than 0.5 μm, are removed compared to the ambient air when in use. In a particularly preferred embodiment it is to be understood as the “surface”, defined by the discrete points in the space between the air outlets (10) of said air treatment device and the point of care (2) at the level (35) of the geometrical centre point (37) of the point of care (2), at which cat allergen concentration is reduced by a factor of 30 and total breathing zone particulate exposure by a factor of 3000 for particles >0.5 μm and 3700 for particles >10 μm when in use.

In accordance with the above, said TLA based clean air zone (31) generated by an air treatment device according to the present invention, e.g. personal breathing zone, is in the context of the present invention to be understood as the air in a certain volume of space between the air outlets (10) of said air treatment device and the point of care (2) at the level (35) of the geometrical centre point (37) of the point of care (2), in which the level of airborne fine particle counts (i.e. particulate matter particles s 2.5 μm), is reduced at least 75% compared to that of the ambient air when in use. In certain preferred embodiments it is to be understood as the air in a certain volume of space between the air outlets of said air treatment device and the point of care (2) at the level (35) of the geometrical centre point (37) of the point of care (2) in which at least 95% of particles larger than 0.5 μm are removed compared to the ambient air when in use. In a particularly preferred embodiment it is to be understood as the air in a certain volume of space between the air outlets (10) of said air treatment device and the point of care (2) at the level (35) of the geometrical centre point (37) of the point of care (2) in which cat allergen concentration is reduced by a factor of 30 and total breathing zone particulate exposure by a factor of 3000 for particles >0.5 μm and 3700 for particles >10 μm when in use.

In accordance with the above the “outer boundary” of said clean air zone (31) generated by an air treatment device according to the present invention at the point of care (2), e.g. a personal breathing zone, is at the level of a point of care (35) to be understood to be defined as the shortest distance, R1, from the geometrical centre point (37) of said clean air zone (31) at the level (35) of the geometrical centre point (37) of the point of care (2), to another point, at the level (35) of the geometrical centre point (37) of the point of care (2), at which the level of airborne fine particle counts (i.e. particulate matter particles s 2.5 μm), is reduced at least 75% compared to that of the ambient air when in use. In certain preferred embodiments it is to be understood as the shortest distance, R1, from the geometrical centre point (37) of said clean air zone (31) at the level (35) of the geometrical centre point (37) of the point of care (2), to another point, at the level (35) of the geometrical centre point (37) of the point of care (2), at which at least 95% of particles larger than 0.5 μm are removed compared to the ambient air when in use. In a particularly preferred embodiment it is to be understood as the shortest distance, R1, from the geometrical centre point (37) of said clean air zone (31) at the level (35) of the geometrical centre point (37) of the point of care (2), to another point, at the level (35) of the geometrical centre point (37) of the point of care (2), at which cat allergen concentration is reduced by a factor of 30 and total breathing zone particulate exposure by a factor of 3000 for particles >0.5 μm and 3700 for particles >10 μm when in use.

In the context of the present invention the dimensions of a TLA based clean air zone (31) generated inter alia at the point of care (2), e.g. the distance, R1, to its “outer boundary”, at the level (35) of the geometrical centre point (37) of the point of care (2), from its geometrical centre point (37), at the level (35) of the geometrical centre point (37) of the point of care (2), whether in whole or in part, is preferably defined in mm.

In the context of the present invention the distance, R1, to the “outer boundary” of a TLA based clean air zone (31) generated inter alia at the point of care (2), from its geometrical centre point (37), at the level (35) of the geometrical centre point (37) of the point of care (2), is preferably 150 mm or more, such as 200 mm, for example 250 mm, such as 300 mm, for example 350 mm, such as 400 mm, for example 450 mm, such as 500 mm, for example 550 mm, such as 600 mm, for example 650 mm, such as 700 mm, for example 750 mm.

In particularly preferred embodiments of the present invention the distance, R1, to the “outer boundary” of a TLA based clean air zone (31) generated inter alia at the point of care (2), from its geometrical centre point (37), at the level (35) of the geometrical centre point (37) of the point of care (2), is 300 mm or more, such as 400 mm, for example 450 mm, such as 500 mm, for example 550 mm, such as 600 mm, for example 650 mm, such as 700 mm, for example 750 mm.

In the context of the present invention the size of the “surface area” defined by the “surface” of a TLA based clean air zone (31) generated inter alia at the point of care (2), whether in whole or in part, is preferably defined in mm2.

In the context of the present invention the “volume” of a TLA based clean air zone (31) defined by the “surface” of said TLA based clean air zone (31) generated inter alia at the point of care (2), whether in whole or in part, is preferably defined in mm3.

The TLA based clean air zone (31) generated by an air treatment device according to the present invention may take any form that has “surfaces” in 3 dimensions; e.g. x, y and z.

In preferred embodiments of the present invention the TLA based clean air zone (31) generated by an air treatment device according to the invention will have a form, which has a relatively large plane face, at the level (35) of the geometrical centre point (37) of the point of care (2), also referred to as the bottom base of said clean air zone (31), compared to the plane face at the air outlets (10) of the air treatment device, also referred to as the top base of said clean air zone (31), and its overall “surface” will be defined further by faces intersecting in lines.

Geometrical shapes of relevance to TLA based clean air zones (31) generated by an air treatment device according to the present invention would include, but are not limited to:

Partial Spheres: where points on the “surface” of the TLA based clean air zone (31) generated inter alia at the point of care (2) are substantially at an equal distance, R1, from a geometrical centre point (37), regardless of whether being at the level (35) of the geometrical centre point (37) of the point of care (2).

Partial ellipsoids: where points on the “surface” of the TLA based clean air zone (31) generated inter alia at the point of care (2) can be said to substantially correspond to points generated by deforming a sphere by means of directional scalings, or more generally, by an affine transformation. In such a situation points on the “surface” of the TLA based clean air zone (31) generated inter alia at the point of care (2) being above the level (35) of the geometrical centre point (37) of the point of care (2) may be at a distance from the geometrical centre point (37), which is either larger than or smaller than the distance, R1, from the geometrical centre point (37), of points on the “surface” of the TLA based clean air zone (31) generated inter alia at the point of care (2) at the level (35) of the geometrical centre point (37) of the point of care (2).

Partial Tori: where points on the “surface” of the TLA based clean air zone (31) generated inter alia at the point of care (2) can be said to substantially correspond to points generated by revolving a circle in three-dimensional space about an axis coplanar with the circle.

Cylinders: where points on the “surface” of the TLA based clean air zone (31) generated inter alia at the point of care (2) can be said to substantially correspond to points generated by lines connecting two parallel circular bases of equal or different size.

Cones: where points on the “surface” of the TLA based clean air zone (31) generated inter alia at the point of care (2) can be said to substantially correspond to points generated from a circular base and a curved side that ends in one point.

Pyramids: where points on the “surface” of the TLA based clean air zone (31) generated inter alia at the point of care (2) can be said to substantially correspond to points generated from a polygon (e.g. triangular or square) base and triangle sides ending in one point.

Prisms: where points on the “surface” of the TLA based clean air zone (31) generated inter alia at the point of care (2) can be said to correspond to points generated two congruent and parallel faces, e.g. in the form of rectangular, triangular, octagonal or hexagonal prisms.

Combinations of any of the above forms.

In preferred embodiments according to the present invention TLA based clean air zones (31) generated by an air treatment device according to the present invention may take a form which has “surface”s substantially corresponding to partial spheres or partial ellipsoids.

In certain preferred embodiments, e.g. partial spheres or partial ellipsoids, one dimen-sion of a TLA based clean air zone (31) generated inter alia at the point of care (2) according to the invention, e.g. x, might be relatively minute as compared to the other two dimensions of the TLA based clean air zone (31) generated, e.g. y and z. Also, in certain preferred embodiments, e.g. partial spheres or partial ellipsoids, one of the dimensions of a TLA based clean air zone (31) generated inter alia at the point of care (2) according to the invention, e.g. y, might be relatively extensive as compared to the other two dimensions, e.g. x and z.

As already mentioned above the devices of the present invention when in use allow for both an improved clean TLA flow, an improved clean air distribution and an improved clean air displacement/evacuation from the clean air zone (31) generated inter alia at the point of care (2), leading to a significant improvement of the stability of the clean air zone (31) at the point of care (2) and a significant reduction in the time needed for the clean air zone (31) at the point of care (2) to recover, if having been disturbed, e.g. by movements of the individual in need of care resting at the point of care (2), i.e. for it to re-establish a situation in which the level of airborne fine particle counts (i.e. particulate matter particles s 2.5 μm), is reduced at least e.g. 75% compared to that of the ambient air.

Thus, the functioning of devices according to the present invention is much less dependent on the specific placement of the device relative to the point of care (2), e.g. controlled personal breathing zone, than the devices of the prior art. This has a significant positive impact on the level of compliance, e.g. therapeutic compliance and hence clinical effect, which can be obtained with a device according to the present invention compared to the level of compliance, e.g. therapeutic compliance, obtainable with prior art devices. Thus, compared to the prior art devices the devices of the present invention are not prone to displaying a limited efficiency when the clean air continuously supplied to the clean air zone (31) generated inter alia at the point of care (2) when the device is in use cannot freely move away from the point of care (e.g. the personal breathing zone) in all directions, i.e. a device according to the present invention can also function when unhindered movement of air is not possible in all directions away from the point of care (i.e. in all directions covered by the 360° around the circumference making of the area making up the point of care). Consequently, the devices of the present invention also function in situations where the clean air continuously supplied to the clean air zone (31) generated inter alia at the point of care (2) when the device is in use can only truly freely move in the direction of (and be evacuated from) one side of the point of care (2), e.g. a resting place (e.g. bed) in or on which an individual in need of care is resting, and/or e.g. only in the direction of the foot end of the resting place (e.g. bed). This is particular true in cases where the TLA flow continuously supplied to generate the clean air zone (31) when the device is in use cannot otherwise move away from the point of care (2) in the direction of the head end of a resting place (e.g. bed) in or on which an individual in need of care is resting and/or cannot otherwise move away from the point of care (2) in the direction of one side of the resting place (e.g. bed), e.g. if the resting place (e.g. bed) is placed alongside at least one wall or in a corner. Also, individuals often move around, when resting in or on a resting place and sometimes will be positioning their head, and hence e.g. nose and mouth, close to the proximity to the boundary of the TLA based clean air zone (31) generated inter alia at the point of care (2) when the device is in use, e.g. close to the distance, R1, from the geometrical centre point (37) of the clean air zone (31), at the level (35) of the geometrical centre point (37) of the point of care (2), to its “outer boundary”. If there is a wall close by at this point the air cleanliness would in most situations have been disturbed when using the prior art TLA systems, while it remains practically undisturbed in case of a device according to the present invention.

The above entails that the devices of the present invention are particularly relevant in case of providing a clean air zone (31) for e.g. children lying in their bed, as both the size and the cleanliness of the clean zone (31), otherwise intended to be generated by the device at the point of care (2) when in use, is much more stable in such situations than what may be observed for prior art devices since objects, e.g. an individual, can freely move or be moved around in the clean zone (31, within the distance R1 from the geometrical centre point 37) without endangering the air cleanliness of the clean air zone (31). Finally, compared to prior art devices, devices of the present invention are designed in a way, which facilitates standard maintenance procedures, such as e.g. filter-change, by the user, e.g. without an accompanying risk of unwanted contamination of the clean-zone through spillage of material from the used filter.

Also, compared to most prior art devices, the functioning of the devices of the present invention are not dependent on the inlet of air from floor level for optimal performance, and, hence, are, in contrast to the devices of the prior art, not dependent on a thermal stratification at floor level. Quite to the contrary the devices of the present invention rely solely on a supply of air evacuated from the immediate proximity of the clean air zone (31) generated inter alia at the point of care (2) when in use, either at or directly above the level (35) of the geometrical centre point (37) of the point of care (2).

In the context of the present invention the expression “the immediate proximity” of the clean air zone generated at the point of care is to be understood as being defined in accordance with the dimensions of the clean air zone (31) generated inter alia at the point of care (2) by the air treatment device in question in line with the above definition (of the clean air zone). Thus, in the context of the present invention “the immediate proximity” of the clean air zone (31) generated inter alia at the point of care (2) when the device is in use is to be understood as being defined as a point, which is placed at a distance, R2, from the geometrical centre point (37) of the clean air zone (31) generated by an air treatment device according to the present invention at the point of care (2) when in use, e.g. at the level (35) of the geometrical centre point (37) of the point of care (2), which distance is larger than, but less than two times, the distance from the same geometrical centre point (37) to the “outer boundary” (i.e. “surface”) of said clean air zone (31) generated by an air treatment device according to the present invention at the point of care (2) when in use, e.g. a personal breathing zone, at level (35) of the geometrical centre point (35) of the point of care (2), as defined above, i.e. R1. That is to say, “the immediate proximity” of the clean air zone (31) generated inter alia at the point of care (2) when the device is in use is to be understood as being defined as a point, which is placed at a distance, R2, from the geometrical centre point (37) of the clean air zone (31) generated by an air treatment device according to the present invention inter alia at the point of care (2), e.g. at the level (35) of the geometrical centre point (37) of the point of care (2), which distance is larger than, but less than two times, the shortest distance from the geometrical centre (37) of said clean air zone (31) at the level (35) of the geometrical centre point (37) of the point of care (2), to another point at which the level of airborne fine particle counts (i.e. particulate matter particles ≤2.5 μm), is reduced at least 75% compared to that of the ambient air, i.e. R1. In certain preferred embodiments “the immediate proximity” of the clean air zone (31) generated inter alia at the point of care (2) when the device is in use is to be understood as a distance, R2, being larger than, but less than two times, the shortest distance from the geometrical centre (37) of said clean air zone (31) at the level (35) of the geometrical centre point (37) of the point of care (2), to another point at which at least 95% of particles larger than 0.5 μm are removed compared to the ambient air, i.e. R1. In a particularly preferred embodiment “the immediate proximity” of the clean air zone (31) generated inter alia at the point of care (2) is to be understood as a distance, R2, being larger than, but less than two times, the shortest distance from the geometrical centre (37) of said clean air zone (31) at the level (35) of the geometrical centre point (37) of the point of care (2), to another point at which cat allergen concentration is reduced by a factor of 30 and total breathing zone particulate exposure by a factor of 3000 for particles >0.5 μm and 3700 for particles >10 μm, i.e. R1.

In accordance with the above the expression “the immediate proximity” of the clean air zone (31) generated inter alia at the point of care (2) when the device is in use is in the context of the present invention to be understood as being a point, which is placed at a distance, R2, from the geometrical centre point (37) of the clean air zone (31) generated by an air treatment device according to the present invention at the point of care (2) when in use, e.g. at the level (35) of the geometrical centre point (37) of the point of care (2), which distance, R2, is larger than, but less than two times, the distance, R1, from the same geometrical centre point (37) to the “outer boundary” (i.e. “surface”) of said clean air zone (31) generated by an air treatment device according to the present invention inter alia at the point of care (2) when in use, e.g. a personal breathing zone, at the level (35) of the geometrical centre point (37) of the point of care (2), as defined above.

That is to say the expression “the immediate proximity” of the clean air zone (31) generated inter alia at the point of care (2) is in the context of the present invention to be understood as defining a distance, R2, from the geometrical centre point (37) of the clean air zone (31) generated by an air treatment device according to the present invention inter alia at the point of care (2), e.g. at the level (35) of the geometrical centre point (37) of the point of care (2), which may be defined as 2*R1>R2>R1.

The devices of the present invention are adapted to provide a substantially laminar descending downwardly directed purified air flow towards or into e.g. a controlled personal breathing zone of a user or individual in need of care or another point of care (2), having a difference in air temperature between the supplied air and the ambient air as measured at the level of the personal breathing zone of the individual in need of care or at the level (35) of the geometrical centre point (37) of the point of care (2) and wherein the difference in air temperature is maintained within a range of 0.1 to 3° C., such as 0.3 to 1° C., or 0.5 to 0.8° C., cooler than the ambient air at the level of the personal breathing zone or point of care.

The technical effect achieved by placing 1) the at least one air-inlet (4) in the immediate proximity of the point of care (2), e.g. controlled personal breathing zone, i.e. at a distance, R2, from the geometrical centre point (37) of the clean air zone (31) generated by an air treatment device according to the present invention inter alia at the point of care (2), e.g. at the level (35) of the geometrical centre point (37) of the point of care (2), which may be defined as 2*R1>R2>R1, and 2) the at least one air outlet (10) just above the level (35) of the geometrical centre point (37) of the point of care (2), e.g. controlled personal breathing zone, is that a well-defined and more stable zone of clean air having the required temperature of 0.1 to 3° C., such as 0.3 to 1° C., or 0.5 to 0.8° C., cooler than the ambient air at the level (35) of the geometrical centre point (37) of the point of care (2), e.g. controlled personal breathing zone, is thereby generated. Thus, compared to the devices of the prior art, devices according to the present invention allow for both an improved clean airflow, an improved clean air distribution and an improved air evacuation from the clean air zone at the point of care (2), leading to a significant improvement of the stability of the clean air zone (31) generated inter alia at the point of care and a significantly shortened period of time needed for the clean air zone (31) generated inter alia at the point of care to recover if having been disturbed, e.g. by movements of or by an object or individual in need of care resting at the point of care.

The fact that the above-mentioned effects would be obtained by locating the one or more air inlets (4) in the immediate proximity of the clean air zone (31), e.g. a controlled personal breathing zone, generated by the device at the point of care (2), i.e. at a distance, R2, from the geometrical centre point (37) of the clean air zone (31) generated by an air treatment device according to the present invention inter alia at the point of care (2), e.g. at the level (35) of the geometrical centre point (37) of the point of care (2), which may be defined as 2*R1>R2>R1, is very surprising and would not have been possible to foresee on beforehand by an evaluation of the scientific evidence available in the prior art.

In fact based on an evaluation of the scientific evidence available in the prior art the only reasonable inference that could reasonably have been drawn a priori would have been that placing the one or more air inlets (4) in the immediate proximity of the clean air zone (31), e.g. a controlled personal breathing zone, generated by the device at the point of care (2), i.e. at a distance, R2, from the geometrical centre point (37) of the clean air zone (31) generated by an air treatment device according to the present invention inter alia at the point of care (2), e.g. at the level (35) of the geometrical centre point (37) of the point of care (2), which may be defined as 2*R1>R2>R1, would have led to a detrimental disturbance of the clean air zone (31). Thus, the critical finding of the present invention that the integrity of the clean air zone (31), e.g. controlled personal breathing zone, is not disturbed—but in fact rather strengthened—if the one or more air inlets (4) are placed in the immediate proximity of the clean air zone (31), e.g. controlled personal breathing zone, i.e. at a distance, R2, from the geometrical centre point (37) of the clean air zone (31) generated by an air treatment device according to the present invention inter alia at the point of care (2), e.g. at the level (35) of the geometrical centre point (37) of the point of care (2), which may be defined as 2*R1>R2>R1, and in preferred embodiments in such a way that they are either at the level of or approximately 5-30 centimetres above the level (35) of the geometrical centre point (37) of the point of care (2) and are furthermore placed in such a way that the primary direction vector of the air flow (38) into the at least one of said one or more air inlets (4), cf. FIG. 4e, is at an angle of >=90° and <=270° to the primary direction vector of the air being displaced/evacuated (39) from said controlled clean air zone (31), is very surprising. That is to say, the inlets (4) are in preferred embodiments primarily to be placed so that they are either solely facing a volume of space, the majority of which is at an angle of above or equal to 90° and below or equal to 270°, e.g. 180°, compared to the volume of space from which, air is being displaced/evacuated (39) from said controlled clean air zone (31) during functioning of the device.

In devices according to the present invention at least part of the supply air is evacuated from the surroundings through air inlets (4) either from the immediate proximity of the clean air zone (31) generated inter alia at the point of care (2), either at or directly above the level (35) of the geometrical centre point (37) of the point of care (2). In preferred embodiments the supply air is evacuated from the immediate proximity of the clean air zone (31) generated inter alia at the point of care (2) and directly above the level (35) of the geometrical centre point (37) of the point of care (2).

In the context of the present invention the placement of the one or more air inlets (4) in the immediate proximity of the clean air zone (31) generated inter alia at the point of care (2) is to be construed to mean that they are in case R1, as defined above, is equal to 300 mm, placed more than 300 mm but less than 600 mm from the geometrical centre point (37) of a sphere having its centre at the point of care (2) at the level (35) of the geometrical centre point (37) of the point of care (2). That is to say, in case R1, as defined above, is 300 mm, R2, as defined above, will be 600 mm >R2>300 mm.

In the context of the present invention the placement of the one or more air inlets (4) in the immediate proximity of the clean air zone (31) generated inter alia at the point of care (2) is to be construed to mean that they are, in case R1, as defined above, is between 300 and 500 mm, placed from more than 300 mm to more than 500 mm from the geometrical centre point (37) of a sphere having its centre at the point of care (2) at the level (35) of the geometrical centre point (37) of the point of care (2), respectively. That is to say, in case R1, as defined above, ranges from more than 300 mm to more than 500 mm, R2, as defined above, will be 1000 mm >R2>300 mm.

In the context of the present invention the placement of the one or more air inlets (4) either at or directly above the level (35) of the geometrical centre point (37) of the point of care (2) of the clean air zone (31), e.g. a controlled personal breathing zone, generated by the device in use is to be construed to mean that they are placed approximately 2-50 centimetres above, such as 3-45 centimeters above, e.g. app. 25 centimeters above, that is to say 3-45 centimetres above, such as 4-40 centimeters above, e.g. app. 30 centimeters above, that is to say 5-35 centimetres above, such as 10-25 centimeters above, e.g. app. 10-20 centimeters above the geometrical centre point (37) of a sphere having its centre at the point of care (2) at the level (35) of the geometrical centre point (37) of the point of care (2) and defining the clean air zone, e.g. a controlled personal breathing zone. In preferred embodiments the one or more air inlets (4) will furthermore be placed in such a way that the primary direction vector (38) of the air flow into these air inlets (4), cf. FIG. 4e, happens in a direction which is at an angle of >=90° and <=270° to from the primary direction vector of the flow of air being displaced/evacuated (39) from the clean air zone (31) generated by the device, e.g. in case of the embodiment shown in FIG. 4a1 and 4a2 by placing the one or more inlets (4) on the opposite side of the device compared to the side of the device on which the one or more air outlets (10), thereby ensuring that the primary direction vector of the airflow (38) into the at least one of said one or more air inlets (4) located in the immediate proximity of said controlled clean air zone (31) generated by the device (1) when in use, is at an angle of >=90° and <=270° to the primary direction vector of the air being displaced/evacuated (39) from said controlled clean air zone (31).

Very surprisingly it has been found that the stability of the clean air zone (31) generated by an air treatment device according to the present invention is not substantially affected if the inlets (4) are constructed/located according to the above. Thus, a person skilled in the art would not as a starting point place an air inlet (4) in the immediate proximity of the TLA based clean air zone in a position, which must be considered to be asymmetrical compared to the general or primary direction vector of the clean TLA flow of the clean air zone (31) generated inter alia at the point of care (2), since such a positioning of the air inlet (4) would as a starting point be expected to significantly impact the flow direction of the supply of clean air into the clean air zone (31). However, the combination of this somewhat asymmetrical positioning of the air inlet(s) (4) and the somewhat higher den-sity of the cooler air (compared to ambient air) supplied as a TLA flow to the clean air zone (31) apparently both ensures that the general and primary direction vector of the TLA flow of clean air at the point of care (2) can be maintained and at the same time effectively evacuates/displaces air from the point of care (2), which would otherwise be trapped and build-up e.g. at the headboard or at a close by wall, thereby potentially giving rise to turbulence or other disturbances to the clean air zone (31). Without wishing to be bound by theory the current hypothesis behind this surprising finding is that while blowing might have a disturbing effect on temperature-controlled laminar air (TLA) flow even if effected at some distance from the relevant TLA flow, the disturbing effect of suction (or perhaps rather evacuation of air) is much less pronounced. This might also be part of the reason why it is observed, for a device according to the present invention, that even if the one or more air inlets (4) are placed in the immediate proximity of the clean air zone (31), e.g. a controlled personal breathing zone, generated when the devices is in use, they are particularly less prone to negatively affect the clean air zone (31) if they are placed in such a way that the primary direction vector of the air flow (38) into the air inlets (4), cf. FIG. 4e, happens in a direction which is at an angle of >=90° and <=270° to the primary direction vector of the air being displaced/evacuated from the personal breathing zone in the immediate proximity of the device, e.g. in case of the embodiment shown in FIGS. 4a1, 4a2, 4c, 4d and 4e by placing the one or more inlets (4) on the opposite side of the device compared to the side of the device on which the one or more air outlets (10), are placed and thereby ensuring that the primary direction vector of the air flow (38), cf. FIG. 4e, into the at least one of said one or more air inlets (4) located in the immediate proximity of said controlled clean air zone (31) generated by the device (1) when in use, is at an angle of >=90° and <=270° to the primary direction vector of the air being displaced/evacuated (39) from said controlled clean air zone (31).

Also the inventors currently speculate that the relative placement of the one or more air inlets (4) and the one or more air outlets (10) (including their placement relative to the point of care) of a device according to the present invention do in fact effectively stabilize the TLA based clean air zone (31) generated inter alia at the point of care, in the sense that, as compared to the prior art devices, the specifics, and not least stability, of a TLA based clean air zone (31) generated by an air treatment device according to the present invention will, as the inlets (4) are placed in the immediate proximity of the clean air zone (31), e.g. a controlled personal breathing zone, to a certain degree be determined both by the placement of these inlets (4) and the placement of the outlets (10). In contrast the specifics/stability of a TLA based clean air zone (31) generated by a prior art device, is primarily if not mainly or solely determined by the placement of the outlets (10).

Apart from being more stable in use, several other advantages are associated with this feature. One is that the well-defined zone of clean air (31) thereby generated, will-due to the recirculation of air from the point of care (2) rather than e.g. uptake of air from floor level (such as prior art)—be increasingly cleaner during prolonged periods of operation. Further the inlet air will be less mixed with ambient air when the inlets (4) are placed in close proximity to the clean zone (31) generated compared to having the air inlets at floor level, which increases the over-all efficiency of the air-cleaning device, e.g. with respect to cooling, and the life-time of the filter (7). This in turn increases the period of service-free operation of the device as the filter (7) is the most short-lived part of the device. Another advantage is that the over-all power consumption needed to cool the air of the clean air zone (31) generated by the device to any given temperature below the ambient temperature will over time decrease, since the recirculated air will continuously be cooled down to the desired temperature during operation.

The filter (7) to be used in a device according to the present invention is preferably a high efficiency particulate air filter, preferably a filter capable of removing at least 75%, at least 85% or at least 95% of particles having a size above 0.5 um, or higher if needed at point of care. In other embodiments, any suitable filter media or device adapted to filter particles or gases unwanted at the point of care (2) may be used. Including for example any combinations of fiberglass and/or polymer fiber filters, or elec-tro static filters, or hybrid filters (i.e. charging incoming particles and/or the filter media), or radiation methods (i.e. UV-light), or chemical and/or fluid methods, or activated carbon filters or other filter types.

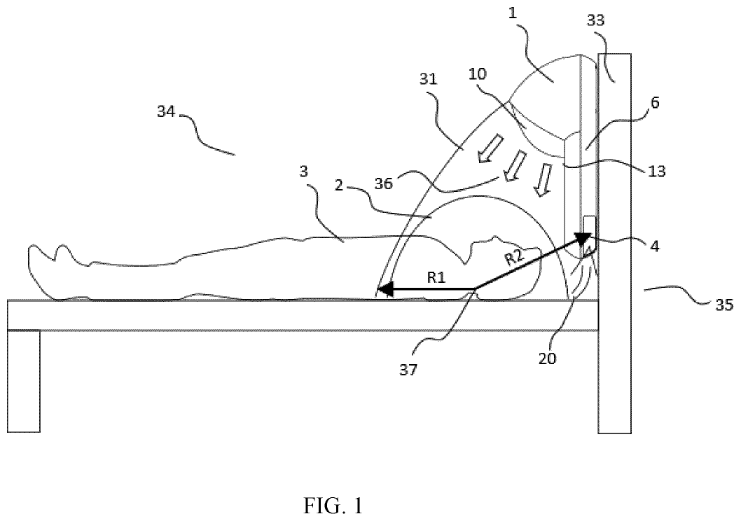

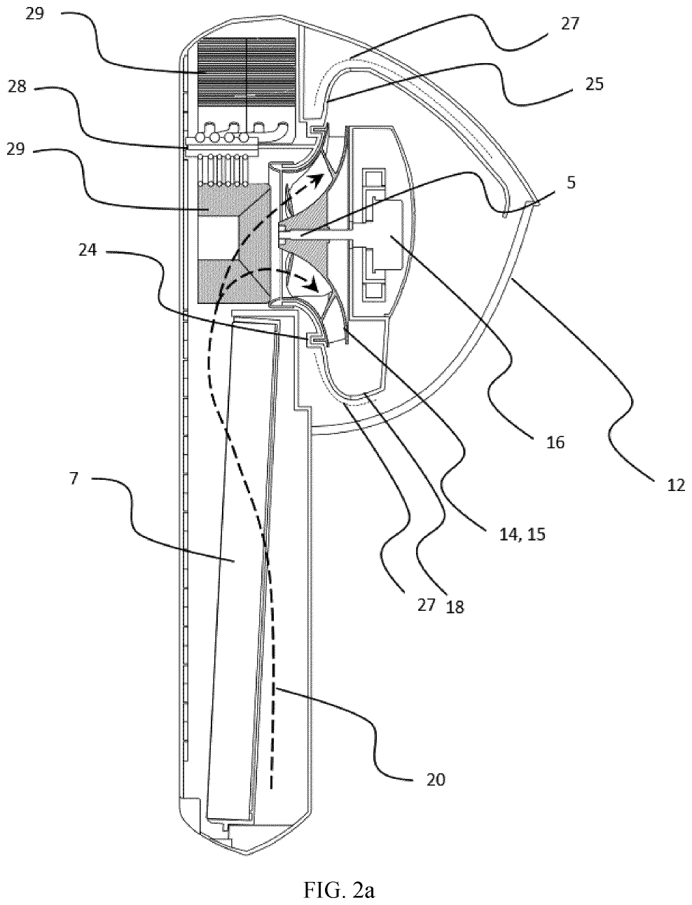

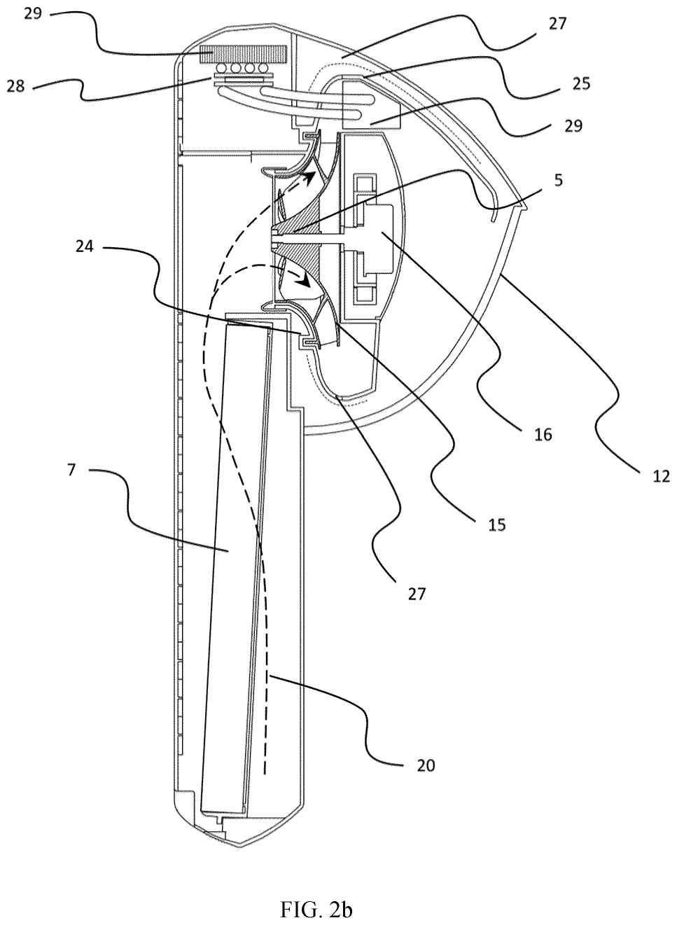

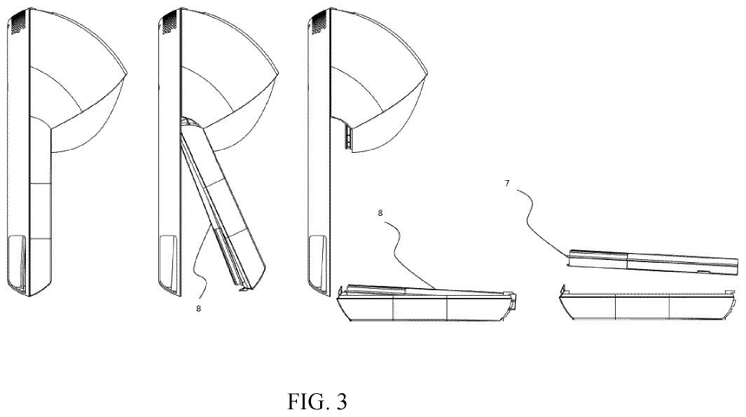

The day-to-day operation of a device according to the present invention may be further improved by incorporating the one or more filters (7) into a filter compartment, into which the filter (7) can be inserted or replaced by dismounting the filter compartment from the front of the device, see FIG. 3.

In further embodiments the TLA devices of the present invention may comprise a filter compartment, which can be dismounted/detached from the device with a release mechanism in such a way that the outermost side of the filter (7) in the filter compartment faces downwards, when the compartment has been dismounted/detached from the device, see FIG. 3. This will enable the change of the filter (7) in the filter compartment when the filter compartment is in an horizontal position with the outermost side of the filter facing downwards, whereas the clean side of the filter (8) will be facing up-wards. When replacing the filter (7), both the user and the point of care will then be protected from the collected allergens and dust which will be contained within the filter compartment. The filter compartment can then be placed in a plastic bag (preferably, if applicable, the plastic bag having contained the re-placement filter) wherein the used filter (7) may be released from the compartment with a mechanism. The filter compartment can then be removed from the plastic bag, still in a vertical position, and re-mounted on the device with a new filter (7) placed in the compartment, which will result in a minimal exposure of the user and the point of care to allergens and dust. In a particularly preferred embodiment of the present invention, the likelihood of particle contamination of e.g. a sleeping area during filter replacement will thereby be significantly reduced.

An example of a TLA device (1) according to the present invention and a possible use thereof is shown in FIG. 1, including the TLA-based clean air zone (31) generated inter alia at a point of care (2). The device shown has been adapted to provide a substantially laminar descending downwardly directed purified air flow (36) towards said point of care (2) having a difference in air temperature to the ambient air (34) as measured at the point of care (2) at the level (35) of the geometrical centre point (37) of the point of care (2) within a range of 0.1 to 3° C., cooler than the ambient air (34) at the level (35) of the geometrical centre point (37) of the point of care (2), said device comprising:
one or more air inlets (4),
one or more air outlets (10), the at least one of said outlets (10) is located above the level (35) of the geometrical centre point (37) of the point of care (2) and adapted to discharge said substantially laminar, downwardly directed purified air flow (36),
one or more filters (7),
a fan assembly (5),
an air temperature adjustment system adapted to provide either heating or cooling of said supply air stream, and
a housing (6),

said device being further characterised in that at least one of said one or more air inlets (4) is/are located in the immediate proximity of said controlled clean air zone (31) generated inter alia at the point of care (2) by the device (1) when in use, either at or directly above the level (35) of the geometrical centre point (37) of the point of care (2) and at a distance, R2, from the geometrical centre point (37) of said clean air zone (31) at the point of care (2), at the level (35) of the geometrical centre point (37) of the point of care (2), which distance, R2, is larger than, but less than two times, the distance, R1, from the same geometrical centre point (37) of said clean air zone (31) at the point of care (2) to the “outer boundary” of said clean air zone (31), at the level (35) of the geometrical centre point (37) of the point of care (2). Also, in the embodiment shown in FIG. 1 the air treatment device (1) has been adapted to generate said controlled clean air zone (31) at said point of care (2) by displacing body convection from an individual in need of care at rest at said point of care (2) thereby generating said controlled clean air zone (31) in the form of a controlled personal breathing zone for said individual at rest at said point of care (2), and the air inlets (4) placed in the immediate proximity of the clean air zone (31) for the evacuation of air from the clean air zone (31) are in the embodiment shown in FIG. 1 placed directly above the point of care.

As can be seen from FIG. 1, the TLA device is preferably designed for vertical mounting, and the device may, thus, e.g. be wall-mounted.

In most embodiments the air outlet(s) (10) of a device according to the present invention is/are located close to or at top of the clean air zone (31) generated by the device when in use.

Due to the technical effect achieved by placing at least one of the air-inlets (4) close to the clean air zone (31) generated by the device at inter alia the point of care (2) when in use, e.g. close to the personal breathing zone, and the air-outlet(s) (10) above the level (35) of the geometrical centre point (37) of the point of care (2), e.g. personal breathing zone, the devices of the present invention will still be able to generate a well-defined clean air zone (31) having the required temperature of 0.1 to 3° C., such as 0.3 to 1° C., or 0.5 to 0.8° C., cooler than the ambient air at the level (35) of the geometrical centre point (37) of the point of care (2) even if placed on walls or in corners.

At the same time the positioning of the device, very close to the point of care (2), e.g. user/“individual in need of care” 's breathing zone, poses a restriction on the capabilities of the device, in that it must be able to generate the desired well-defined clean air zone (31) having the required temperature of 0.1 to 3° C., such as 0.3 to 1° C., or 0.5 to 0.8° C. cooler than the ambient air at the level (35) of the geometrical centre point (37) of the point of care (2), e.g. personal breathing zone, without giving rise to a noise level, which would be incompatible with a placement very close to the point of care (2), e.g. the user/“individual in need of care”.

Several details of a device in accordance with the present invention may assist in ensuring a particular low noise level when in use. For example the applicable filter (7), e.g. capable of removing at least 75%, at least 85% or at least 95% of particles having a size above 0.5 um, may be provided with a relatively large filter area as compared to the area covered by the clean air zone generated, e.g. a filter having an filter media area which is at least twice the area covered by the clean air zone (31) at the point of care (2). The larger the filter media area is, the lower the air velocity and pressure difference over the filter (7) required for operation will be. Thus, a larger filter media area will all other things being equal contribute to reducing the generated noise. In certain preferred embodiments the area covered by the clean air zone (31) at the point of care (2) may be approximately 0.10 m² whereas the filter media area may be approximately 2 m², i.e. resulting in a filter media area, which is 20 times larger than the area covered by the clean air zone (31) generated inter alia at the point of care by the device when in use.

Further, a number of possible features, related to the blower or fan assembly (5) of the device, may be directed to increasing its efficiency, and accordingly to reduce the con-taminant noise level and energy consumption during its use.

In general, see e.g. FIG. 2, a TLA device according to the present invention will comprise:
an air inlet (4) through which an air flow is directed to a fan assembly (5) comprising at least a fan (14) and an outer fan housing (18),
an outlet part of said outer fan housing.

The impeller/fan (14) placed in the outer fan housing (18) of a TLA device according to the present invention will typically comprise a mixed flow/turbo fan/impeller (15) and a motor (16) for driving said fan/impeller. Said motor (16) and mixed flow fan/impeller (15) will then work to generate an air flow to the outlet part of the outer housing of said fan assembly.

A fan assembly of a TLA device according to the present invention will typically also comprise a drive circuit for actuating said motor, which drive circuit is connected to a programmable controlling unit.

A fan assembly according to the present invention will preferably be characterised by comprising a mixed flow or turbo impeller (15) in the form of a closed impeller construc-tion having a top, a bottom and an internal impeller chamber divided into a plurality of sub chambers by means of impeller blades or vanes. This will allow for the fan assembly to comprise an effective air pressure sealing between the impeller and the impeller house. In a particularly preferred embodiment of a fan assembly according to the present invention the air pressure sealing (24) between the impeller and the impeller house will be in the form of a labyrinth-type air-seal.

An efficient air pressure sealing inhibiting air with high pressure (at the impeller outlet) to leak back to the suction side (impeller inlet) significantly adds to the efficiency of an air cleaning device according to the present invention allowing the impeller to run at lower rounds per minute (rpm's) and thus reduces the noise of the device during operation.

In contrast to previous TLA devices a device according to the present invention is inter alia characterized by the one or more air inlets (4) being located in the immediate proximity of the clean air zone (31), e.g. a controlled personal breathing zone, generated by the device at the point of care (2), e.g. at the level (35) of the geometrical centre point (37) of the point of care (2), and not e.g. at floor level.

As noted above, a skilled person would as a starting point be somewhat skeptical in relation to placing an air inlet (4) of an air treatment device in the immediate proximity of the clean air zone (31) otherwise generated by the device when in use, since such a positioning of the air inlet (4) would a priori be expected to significantly impact the general and primary direction vector of the clean TLA air flow supplied from the air outlets (10) of the device.

Also, in general air temperature will be expected to be lover at the level of the floor compared e.g. to the temperature at the level of typical points of care (2), e.g. the personal breathing zone of a bed. Thus, apart from the above a skilled person would also speculate that a TLA-device according to the present invention would—being characterised inter alia by air inlets (4) at or directly above the level (35) of the geometrical centre point (37) of the point of care (2) face challenges in relation to providing a more efficient cooling of the air than the previously known devices. In certain preferred embodiments, the heat sink (29) fin stack may cover only ¾ of a circle covering the part of the total air volume designated to the supply air. The part of the total air volume bypassing the heat sink is designated to cool e.g. electronics. In a turbo impeller or mixed flow impeller the air flow from the inlet of one section of the impeller leaves the impeller at a corresponding site at the impeller outlet.

Such a design improves the efficiency of the heat-sinks and thus decreases the energy consumption during operation and consequently the resulting noise level during operation. Thus, having the heat sink (26/29) on the inlet (suction) side of the impeller opti-mizes the airflow distribution over the heat sink and reduces the air resistance which in turn reduces the rpm need of the impeller and thereby reduces the noise level.

To reduce the resulting noise level during operation even further certain preferred embodiments of an air treatment device according to the present invention takes advantage of the insertion of a number of micro-perforated panels (27) mounted with Helmholtz resonators at various positions around the fan assembly, see FIG. 2.

The presence of such micro-perforated panels will reduce the resulting noise level during operation significantly, see e.g. US20140271132A1 (Tyler).

While a number of possible temperature regulating elements can be used in an air treatment device according to the present invention, an treatment device comprising a temperature adjustment system comprising a thermoelectric Peltier module (28) is a particularly preferred embodiment of the present invention.

Both heat-pipes and heat-sinks can be made from metal, typically an alloy or a metal with good thermal conductivity, such as a metal selected from the group of metals con-sisting of alumina, copper, steel, brass or the like.

A further drawback with the TLA devices of the prior art is that known devices are only semi-automatic and do not allow for truly personalised operation. In order to overcome this drawback an air-treatment according to the present invention will preferably comprise a programmable controlling unit.

In preferred embodiments an air treatment device according to the present invention further comprises one or more sensors (or cameras) (13), that are coupled to the programmable controlling unit enabling the detection and the monitoring of the ambient air temperature, the outlet air temperature, the “surface” temperature of the clean air zone (31) and the presence or absence of an individual in the clean air zone (31), e.g. at the point of care (2).

A TLA-device according to the present invention should deliver cleaned air at a temperature only slightly (0.1 to 3° C., such as 0.3 to 1° C., or 0.5 to 0.8° C.) below the ambient air temperature at the level (35) of the geometrical centre point (37) of the point of care (2) and at a downward velocity ensuring that the flow of cleaned air not is perceived as a draught.

Accordingly, an air treatment device according to the present invention may comprise at least one sensor or camera (13), e.g. an array of IR sensors and two or more temperature sensors, coupled to a programmable controlling unit and being able to detect surface temperature with a high precision, e.g. a precision of +/−0.1° C. or less at the point of care, e.g. at the “surface” of the clean air zone (31). This level of precision makes it possible to monitor if an evenly distributed decrease in temperature is in fact achieved within the clean air zone (31) generated, when the device is switched on in a real-life environment compared to when it is switched off. In this way the functioning of the clean air zone (31) generated in a real-life environment can be checked, and disturbances (e.g. airflow turbulences from fans or window draughts) that interferes with the TLA clean zone function can be detected and if possible counteracted. Even if this kind of zone-integrity test can only be performed when the system is not being used, i.e. in a situation where nothing is placed in the clean air zone (31), it will allow for a check of the func-tionality of the device upon installation at the point of use without the need for a technician being present.

Preferably, the sensor or camera (13), e.g. an array of IR sensors and two or more temperature sensors, may in addition be able to detect the air temperature at the air outlet(s) (10).

The combination of one or more sensors or cameras (13), e.g. an array of IR sensors and two or more temperature sensors, which, via their coupling to a programmable controlling unit, are able to detect a number of parameters, e.g. the presence or absence of an object, e.g. an individual, i.e. the end user/individual in need of care, in the clean air zone (31), e.g. personal breathing zone, e.g. her or his bed, and, accordingly, will allow the device to be in operation when an object, e.g. individual is present at the point of care (2). This automatic start/stop function improves overall compliance, e.g. therapeutic compliance (adherence to treatment), which is otherwise a large problem in e.g. asthma, as the user does not need to start and stop the device. At the same time it will contribute to less overall energy consumption and less frequent filter re-placements.

In certain preferred embodiments an air treatment device according to the present invention will incorporate components (e.g. a WiFi-device or a GSM-module) allowing for the actual measurements of any of the measured parameters to be reported to qualified healthcare—or technical service professionals, e.g. via the internet. Thus, for instance an air treatment device according to the present invention may e.g. comprise a programmable controlling unit that is programmed to send notifications to technical service professionals, an individual in need of care and/or healthcare provider as to whether or not the device is used according to recommendations. Thus, the device may be programmed to provide documentation of its proper use, which may be advantageous in connection with certain situations, e.g. health-insurance arrangements. Similarly, the device may be programmed to automatically either send a message to a service facility or to prompt the user if technical service of the device is needed or if there is need for user intervention, e.g. filter exchange.

The present invention is also aimed at a method for alleviating symptoms related to exposure to particulate allergens by providing a controlled personal breathing zone of an individual in need of care by the use of an air treatment device according to the present invention.

FIG. 1 shows an embodiment of air treatment device (1) of the invention and its use. The device may e.g. be wall (33) mounted as shown or may be mounted on the head end of e.g. a bed.

The device comprise one or more air inlets (4) which are preferably placed in or very near to, i.e. in the proximity of, the clean air zone (31), e.g. controlled breathing zone, generated at a point of care (2), a filter, a fan assembly and air outlets (10/12) adapted to discharge a substantially laminar descending downwardly directed purified air flow towards the point of care (2), e.g. into the personal breathing zone of an user or individual in need of care (3).

The device preferably includes one or more sensors (or cameras) (13), e.g. an array of IR sensors and two or more temperature sensors, connected to a programmable controlling unit. This combination ensures that the device, in addition to detecting the difference in air temperature between the air supplied from the air outlet(s) (10) and the ambient air temperature at the level (35) of the geometrical centre point (37) of the point of care (2) is also able to detect one or more other features, e.g. the presence of a user/individual in need of care (3) at a suitable distance from the device, e.g. in the personal breathing zone.

The combination of an array of IR sensors and two or more temperature sensors and programmable controlling unit opens an avenue for a truly automatic device control, which significantly adds to a convenient, problem free user experience. E.g. the device enables the detection of an object at the point of care (2), e.g. a user in a bed, and automatically turn on or off depending thereon. It also may detect a user's sleeping patterns (e.g. numbers of turns per night, disturbed sleep etc.). The sensor/controlling unit is also able to directly detect stability of the clean air zone (31) generated inter alia at the point of care (2), e.g. a personal breathing zone, since the sensitivity of an array of IR sensors is +/−0.1° C. or better. The device is able to perform an installation check where the stability of the clean air zone (31) generated is checked when the device is installed. This facility, i.e. a user-performed-installation test, may replace a the visit of a technician for installation, if e.g. the device is moved to another location relative to the point of care (2), or if the point of care is moved to another location in the room. Further, it is possible to program the device continuously to control if it generates a well-defined clean air zone (31), e.g. controlled personal breathing zone, and to give warnings to the user if the clean air zone (31), e.g. controlled personal breathing zone, is unstable due to seasonal variations (cold draught during winter, or use of fans/AC during summer time etc.). A warning—or even a report—may also automatically be sent via a GSM (global system for mobile communication or similar) module from the device to the user or a service-technician. A WiFi- or BlueTooth-device, that provide connection to the internet, may supplement or replace a GSM-module. In either case such communication facilities provide for communication to common handheld devices, such as a smartphone. Thereby a display on the device itself can be avoided.

The location of at least one of the air inlet(s) (4) in or near to, i.e. in the proximity of, the clean air zone (31), e.g. controlled personal breathing zone, at the point of care (2) generated by the device when in use improves evacuation of contaminated air from within and around the clean zone (31). Air that has circulated the clean zone is effectively evacuated (evacuation of “used air”) resulting in a significantly more stable clean air zone (31).

In case of the prior art TLA devices, e.g. the device described by WO 2011042801 (Kris-tensson), it has turned out that the actual location of the bed and hence device in a room is critical for its function. The reason being that zones of stagnated air at walls and/or in corners developed and limited the establishment of the clean zone. The new air treatment devices described herein to a large extent surpasses this limitation.

Compared to the prior art devices the devices of the present invention allow for both an improved clean airflow, an improved clean air distribution and an improved clean air evacuation from the clean air zone (31) at the point of care (2), leading to a significant improvement of the stability of the clean air zone at the point of care (2) and a significant reduction in time needed for the clean air zone (31) at the point of care (2) to recover if having been disturbed, e.g. by movements of the individual in need of care resting at the point of care.

A further advantage of the air treatment devices according to the present invention is that they are significantly more compact, and adapted for easy mounting either on the wall (33) or on e.g. a bed headrest.

FIGS. 2a and 2b show two embodiments of an air treatment device (1) according to the present invention, including the placement of the air inlets (4) relative to the typical clean air zone (31) generated by an device according to the present invention when in use.

Thus, the embodiments shown in FIGS. 2a and 2b include:
one or more air inlets (4),
one or more air outlets (10) adapted to discharge a substantially laminar, downwardly directed purified air flow,
one or more filters (7),
a fan assembly (5),
an air temperature adjustment system adapted to provide either heating or cooling of said supply air stream, and
a housing (6),

The design of devices according to the present invention is directed to minimize pressure drops and accordingly reducing the necessary rotation speed of the impeller and other sources for noise and heat production during operation. Several design-features helps in obtaining this. Minimizing the number of “air bends” of the air flow path (20) within the device reduces total pressure drop and thus noise. The noise is also reduced by operating with relatively large air-inlet- and filter-areas which keeps air-velocities and hence pressure drop low. The specially designed fan assembly (5) is also critical for noiseless operation. The use of micro-perforated panels near the impeller (27) adds to the noise-reduction.

Typically, a device according to the present invention comprises one or more sensors and/or cameras (13), e.g. an array of IR sensors, coupled to a programmable controlling unit and capable of detecting temperature differences with a precision of +/−0.1 degree C. A suitable sensor may be an array of non-contact high precision IR-sensors, which provide non-contact temperature sensing accuracy up to 0.1 degrees C.

The flow of air in a device according to the present invention (1) is generated by the action of a fan (blower) assembly (5). In order to reduce noise and energy consumption, the device is equipped with a specially designed fan assembly (5). Two embodiments of the assembly are shown in FIG. 2. The flow of air in the assembly is generated by rotation of a mixed flow/turbo impeller (15). The rotation of the impeller is generated by a motor (16). The motor (16) may be a DC brushless motor, or any other kind of motor, having a speed which is variable by the control circuit of the device.

The operation of the fan/impeller creates a flow of air entering the assembly via the inlet (4), passing through the impeller (15) and up into a housing (25). In the depicted embodiment the fan assembly (5) further comprise a temperature adjustment system containing e.g. a thermoelectric Peltier module (28) connected to a set of heatsinks (29) via a number of heat-pipes (30). The temperature adjustment system can be mounted directly on top of impeller house housing (25) to form an integrated part of the fan assembly.

To optimise the efficiency, and thus reduce the noise generated during operation, the fan assembly of an air treatment device according to the present invention comprises an air pressure sealing (24) between the impeller (15) and the impeller house (25). The noise generated by the fan assembly can be further reduced by the use of micro-perforated panels (27), just like sinusoidal motor control and impeller tuning ensuring that this is outside the frequency of motor may be applied.

The air pressure sealing of an air treatment device according to the present invention is preferably based on a frictionless labyrinth-type of sealing. This labyrinth-sealing may be a one-stage labyrinth, i.e. a sealing comprising one circumferential fin fitting into one circumferential groove, see FIG. 2, or it may be a two- or higher stage labyrinth seal.

### EXAMPLES

### Example 1

A “provocation test” with statistical calculation and “clean zone” comparison between a TLA device in accordance with the prior art, AIR4 (i.e. WO2012/136728), see FIG. 4b, and a TLA device according to the present invention, AIR5, see FIG. 4a1 and 4a2, was performed. Measurements were made both with a point of care (2), in this case a bed, placed next to the wall and a free-standing bed, i.e. a freestanding point of care (2). The values mentioned in the below table for AIR4 (the prior art) and AIR5 (according to the present invention) e.g. at 0600 mm (on both sides) is an average of the measurements with a bed placed next to the wall and a free-standing bed.

More specifically the tests were performed in two different setups.

In the first set-up, a so-called provocation test, the air cleanliness was measured with a subject at the point of care (2), i.e. in the bed, performing a disturbance of the clean zone and the particle measurement were conducted for a time-period of one minute starting at the point in time, where the disturbance was performed. The particle measurement was furthermore done at the geometrical center point (37) of the clean air zone at a level just above the forehead of the subject positioned in the bed at the center (37) of the point of care (2). In these tests the point of care, i.e. bed, were free-standing.

In the second set-up a TLA device in accordance with the prior art, AIR4 (i.e. WO2012/136728), see FIG. 4b, and a TLA device according to the present invention, AIR5, see FIG. 4a1 and 4a2, were tested with a point of care (2), i.e. a bed, positioned in a corner of a room and particle measurements were performed at the geometrical center point (37) of the clean zone (again at a level just above the forehead of the subject positioned in the bed at the center (37) of the point of care(2)) and at positions R=+/−100 mm, +/−200 mm, respective+/−300 mm, and just above the level (35) of the geometrical centre point (37) of the point of care (2), and while the devices were still in operation (i.e. while a person was still positioned at the geometrical center point (37) of the clean air zone). The tests were performed in accordance with the standard ISO-14664-1: 1999 Clean rooms and associated controlled environments—Part 1. The tests were then repeated with a point of care (2), i.e. a bed, being placed in the opposite corner of the same room.

| 38295 start room: | | [symbol] | = | Moving arm | | | | | | | | |
|---|---|---|---|---|---|---|---|---|---|---|---|---|
| Provocation | | | | | | | | | | | | |
| Measurement No | Time | 1 | | 2 | | 3 | | 4 | | 5 | | Average |
| Vertical Nozzle | 6 | [symbol] | 100% | [symbol] | 100% | [symbol] | 100% | [symbol] | 100% | [symbol] | 100% | 100% |
| | 12 | 450 | 3% | 360 | 5% | 990 | 14% | 180 | 2% | 990 | 8% | 6% |
| | 18 | 180 | 1% | 90 | 1% | 180 | 3% | 0 | 0% | 0 | 0% | 1% |
| | 24 | 180 | 1% | 180 | 3% | 90 | 1% | 90 | 1% | 90 | 1% | 1% |
| | 30 | 180 | 1% | 90 | 1% | 0 | 0% | 0 | 0% | 0 | 0% | 0% |
| | 36 | 0 | 0% | 90 | 1% | 90 | 1% | 180 | 2% | 90 | 1% | 1% |
| | 42 | 0 | 0% | 0 | 0% | 0 | 0% | 90 | 1% | 90 | 1% | 0% |
| | 48 | 90 | 1% | 0 | 0% | 0 | 0% | 0 | 0% | 0 | 0% | 0% |
| | 54 | 180 | 1% | 90 | 1% | 0 | 0% | 0 | 0% | 180 | 1% | 1% |
| 34101 start room: | | | | | | | | | | | | |
| Provocation | | | | | | | | | | | | |
| Measurement No | Time | 1 | | 2 | | 3 | | 4 | | 5 | | Average |
| AIR4 500 mm | 6 | [symbol] | 100% | [symbol] | 100% | [symbol] | 100% | [symbol] | 100% | [symbol] | 100% | 100% |
| from pillow | | | | | | | | | | | | |
| Default cooling | 12 | 5490 | 26% | 4860 | 47% | 5580 | 29% | 2970 | 18% | 5310 | 27% | 29% |
| | 18 | 990 | 5% | 0 | 0% | 90 | 0% | 90 | 1% | 270 | 1% | 1% |
| | 24 | 0 | 0% | 0 | 0% | 0 | 0% | 90 | 1% | 0 | 0% | 0% |
| | 30 | 0 | 0% | 0 | 0% | 0 | 0% | 0 | 0% | 0 | 0% | 0% |
| | 36 | 0 | 0% | 0 | 0% | 0 | 0% | 0 | 0% | 0 | 0% | 0% |
| | 42 | 0 | 0% | 0 | 0% | 0 | 0% | 0 | 0% | 0 | 0% | 0% |
| | 48 | 0 | 0% | 0 | 0% | 0 | 0% | 0 | 0% | 0 | 0% | 0% |
| | 54 | 0 | 0% | 0 | 0% | 0 | 0% | 0 | 0% | 0 | 0% | 0% |

The actual particle measurements were started at the same time as a provocation of the air zone was performed. After 6 seconds the sum of the particles >0.5 μm was read out, i.e. the sum of particles collected 0-6 seconds denoted as “6” under the heading “Time” in the above table. The next readout of particles was for the period 6-12 seconds denoted “12” under the heading “Time” in the above table, etc. For all measurement the first measurement “6” was used as the reference value 100%. Thus, all following measurements are reported as a percentage value compared to the reference value measured at “6”. E.g. for series 1 the reference value was 19000 (100%) and the following measurement at “12” has been calculated as 450/19000=0,024 or 2%.

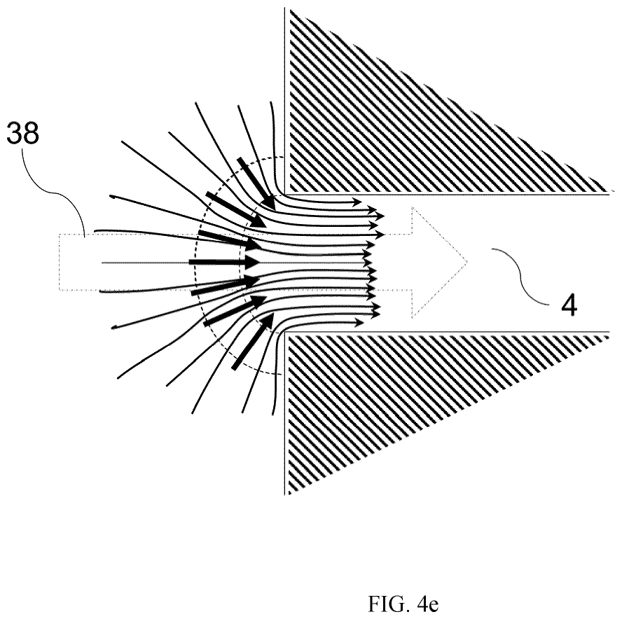

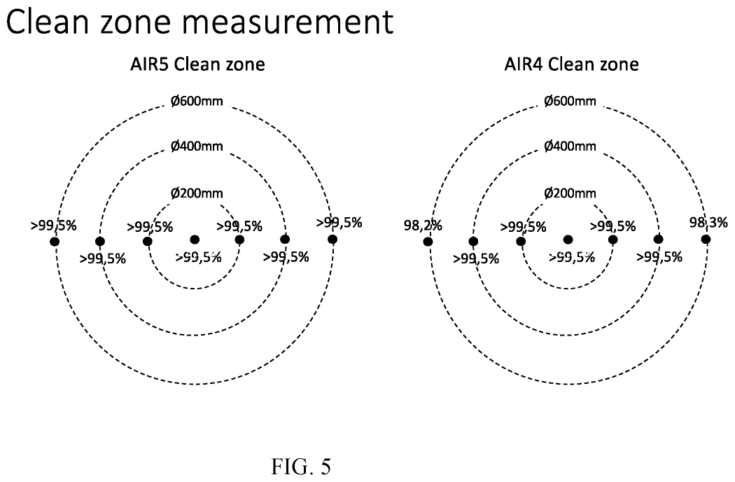

The above data from the provocation test and the results in FIG. 5 show that a device according to the present invention, AIR5, is able to maintain>99.5% clean zone at Ø600 even with the bed placed next to a wall. A device according to the prior art, AIR4, is not able to maintain>99.5%, and especially not when placed next to a wall. In addition the data shows that the total exposure with a device according to the present invention, AIR5, is significantly lower than that with a device according to the prior art, AIR4, i.e. the integrated exposure over the course of 1 minute is significant less with a device according to the present invention, AIR5, compared to that with a device according to the prior art, AIR4, in connection with a provocation of the clean zone.

The results presented in FIG. 5 is a graphical representation of the average particle cleanliness of the clean air zone (31) (compared to ambient air cleanliness at the time of the measurement) at different positions from the geometrical centre point (37) at the level (35) of the geometrical centre point (37) of the point of care (2) and are an average of measurements with a point of care (2), in the form of a bed, placed next to a wall and a free-standing point of care (2) in the form of a free standing bed, respectively. This test demonstrates that the functioning of a TLA device according to the present invention, AIR5, see FIG. 4a1 and 4a2, is independent of whether the point of care, e.g. bed, is position in a corner or not, whereas the functioning of a TLA device in accordance with the prior art, AIR4 (i.e. WO2012/136728), see FIG. 4b is not, and that a TLA device in accordance with the prior art, AIR4, cannot generate a similar level of air cleanliness, when the point of care, e.g. bed, is positioned in a corner.

### LIST OF REFERENCE NUMBERS

1. air treatment device
2. point of care
3. object at point of care, e.g. person/individual in need of care
4. air inlet
5. fan assembly
6. housing of device
7. filter
8. clean side of filter
10. air outlet
12. outlet air
13. sensor or camera
14. fan
15. turbo or mixed flow impeller
16. motor
18. housing of fan assembly
19. panel shielding drive circuit from air flow passing along the air flow path
20. air flow path
21. top of impeller chamber,
22. bottom of impeller chamber
23. impeller blade or vane
24. air pressure sealing
25. impeller house
26. partial cylindrical heat sink
27. micro-perforated panel
28. Peltier module
29. heat-sink
30. heat-pipe
31. clean air zone
32. housing containing filter
33. wall
34. ambient air
35. level of geometrical centre point (37) of the point of care (2)
36. purified air flow
37. geometrical centre point of controlled clean air zone (31) at the point of care (2)
38. primary direction vector of air flow into device through air inlets (4)
39. primary direction vector of air flow being displaced/evacuated from controlled clean air zone (31)

1. An air treatment device for generating a controlled clean air zone inter alia at a point of care, said device being adapted to provide a substantially laminar descending downwardly directed purified air flow towards said point of care having a difference in air temperature to the ambient air, as measured at the point of care at the level of the geometrical centre point of the point of care, within a range of 0.1 to 3° C. cooler than the ambient air at the level of the geometrical centre point of the point of care, said device comprising:
one or more air inlets,
one or more air outlets, the at least one of said outlets is located above the level of the geometrical centre point of the point of care and adapted to discharge said substantially laminar, downwardly directed purified airflow,
one or more filters, capable of removing at least 75% of particles having a size equal to or above 0.5 um,
a fan assembly,
an air temperature adjustment system adapted to provide either heating or cooling of said supply air stream, and
a housing,
wherein at least one of said one or more air inlets is/are located in the immediate proximity of said controlled clean air zone generated inter alia at the point of care by the device when in use and is/are placed:
either at or directly above the level of the geometrical centre point of the point of care and at a distance, R2, from the geometrical centre point of said point of care, at the level of the geometrical centre point of the point of care, which distance, R2, is larger than, but less than two times, the distance, R1, from the same geometrical centre point of said point of care to points, at the level of the geometrical centre point of the point of care, at which the level of airborne fine particle counts in the air is reduced at least 75% compared to that of the ambient air, and
in such a way that the primary direction vector of the air flow into the at least one of said one or more air inlets, is at an angle of >=900 and <=270° to the primary direction vector of the airflow being displaced/evacuated from said controlled clean air zone in the immediate proximity of the device.

2. An air treatment device according to claim 1, being adapted to generate said controlled clean air zone at said point of care by displacing body convection from an individual in need of care at rest at said point of care thereby generating said controlled clean air zone in the form of a controlled personal breathing zone for said individual at rest at said point of care.

3. The air treatment device according to claim 1, wherein the at least one of said one or more air inlets located in the immediate proximity of said controlled clean air zone generated inter alia at the point of care by the device when in use, is/are located at a distance, R2, from the geometrical centre point of said clean air zone at the point of care, at the level of the geometrical centre point of the point of care, which distance, R2, is more than 300 mm but less than 600 mm from the geometrical centre point of said controlled clean air zone at the point of care, at the level of the geometrical centre point of the point of care.

4. The air treatment device according to claim 1, wherein the at least one of said one or more air inlets located in the immediate proximity of said controlled clean air zone generated inter alia at the point of care by the device when in use, is/are located 5-50 cm above the level of the geometrical centre point of the point of care.

5. The air treatment device according to claim 1, wherein part of the housing of the device is removable allowing for insertion or removal of the at least one filter.

6. The air treatment device according to claim 1, wherein the device is configured to be mounted to a wall.

7. The air treatment device according to claim 1, wherein at least one air outlet is located at or close to the top of the controlled clean air zone generated by the device.

8. The air treatment device according to claim 1, which further comprises one or more sensors or cameras in the form of an array of high precision IR-sensors being capable of detecting temperature differences with a precision of +/−0.1° C. or less, being coupled to a programmable controlling unit, and being able to detect surface temperature at the point of care, at the level of the geometrical centre point of the point of care.

9. The air treatment device according to claim 1, wherein the temperature of the air delivered into the controlled clean air zone at the point of care is 0.3 to 1° C. cooler than the ambient air surrounding the controlled clean air zone at the level of the geometrical centre point of the point of care.

10. A method for displacing body convection of an individual in need of care resting at a point of care comprising generating a controlled clean air zone at the point of care by employing the air treatment device according to claim 1.

11. The air treatment device according to claim 1, wherein said airborne fine particle are particulate matter particles having a diameter of ≤2.5 μm.

12. The air treatment device according to claim 9, wherein the temperature of the air delivered into the controlled clean air zone at the point of care is 0.5 to 0.8° C. cooler than the ambient air surrounding the controlled clean air zone at the level of the geometrical centre point of the point of care.
